(19) United States
(12) Patent Application Publication
(10) Pub. No.: US 2020/0225394 A1
(43) Pub. Date: Jul. 16, 2020

(54) POLARIZER AND DISPLAY PANEL

(71) Applicant: Wuhan China Star Optoelectronics Technology Co., Ltd., Wuhan (CN)

(72) Inventors: Chunpeng GUO, Wuhan (CN); Chunhung HUANG, Wuhan (CN)

(73) Assignee: Wuhan China Star Optoelectronics Technology Co., Ltd., Wuhan (CN)

(21) Appl. No.: 16/326,720

(22) PCT Filed: Jan. 24, 2019
(86) PCT No.: PCT/CN2019/072899

§ 371 Date: Feb. 20, 2019

(30) Foreign Application Priority Data
Dec. 19, 2018 (CN) 201811560107.6

(51) Int. Cl. G02B 5/30; B32B 3/26; B23B 51/00

(52) U.S. Cl. CPC G02B 5/3025; B32B 3/266; B32B 2307/42; B32B 2255/00; B32B 2457/20; B23B 51/00

(57) ABSTRACT

A polarizer and a display panel are provided. The polarizer includes a polarizer body and a through hole, and an inner diameter of one end of the through hole is greater than another end of the inner diameter, such that an optical adhesive layer is filled along a sidewall of the through hole. The through hole can be completely filled to prevent air bubbles from being generated between the optical adhesive layer and an inner sidewall of the through hole, thereby improving a yield of the display panel and improving a light transmittance of the through hole.

### FIELD OF INVENTION

The present disclosure relates to the field of display technologies, and more particularly to a polarizer and a display panel.

### BACKGROUND OF INVENTION

In 2007, an original IPHONE was born, and functions of mobile phones were redefined. The biggest change was to cancel a physical keyboard and make a screen a tool for direct interaction between a user and the mobile phone. Although the original IPHONE is not yet mature in various functions, it has led a trend of the times, allowing users to have a new understanding of smartphones, and an importance of the screen has become more prominent.

With the development of technologies, people's pursuit of screen display performances is getting higher and higher, from high resolution to high screen ratio has become more and more a trend of high-end mobile phones. In order to increase the screen ratio, major mobile phone manufacturers are now trying their best. Notch screens are released by APPLE's X series smartphones, and placing a front camera and other devices in the notch screen is provided. SMARTISAN, OPPO, VIVO, and other companies begin to design “beauty tip screens” or “drop screens”. Compared to APPLE's big notch screens, an advantage of the beauty tip screens or the drop screens is that a display area that is buckled out is smaller.

However, whether it is the notch screen, the beauty tip screen, or the drop screen, it will still occupy a certain display area. At present, the industry has proposed a new point of view, namely “blind hole” or in-plane boring. The so-called in-plane boring is to dig a small hole in a middle of a display screen to place a camera.

In order to achieve a performance of the in-plane boring, it is necessary to dig a backlight and a lower polarizer corresponding to a camera position to expose the camera, and a corresponding position of an upper polarizer also needs to be punctured to make a screen transparent, such that a front camera can capture an external image. In order to increase an overall strength of the screen, a cover glass is also required. The cover glass is adhered to the upper polarizer with an optically clear adhesive (OCA).

Current in-plane boring technologies have following technical difficulties. OCA rubber is viscous, but fluidity thereof is not strong. Because a boring of the upper polarizer is a vertical hole, an inner diameter of the vertical hole at different positions is same. When liquid optical adhesive flows into the vertical hole, the liquid optical adhesive cannot flow down along a sidewall of the vertical hole. Therefore, bubbles are easily formed between the optical adhesive and the sidewall of a lower end of the vertical hole, thereby causing abnormal display of the screen and a light transmittance in a boring area is low.

### SUMMARY OF INVENTION

An object of the present disclosure provides a polarizer and a display panel to solve issues that a polarizer in the prior art is prone to generate bubbles and have a low light transmittance during filling an optical adhesive in a through hole.

The present disclosure provides a polarizer including a polarizer body and a through hole penetrating through the polarizer body. An inner diameter of one end of the through hole is greater than an inner diameter of another end of the through hole.

In an embodiment of the present disclosure, the inner diameter of the through hole gradually decreases from the one end of the through hole to the another end of the through hole.

In an embodiment of the present disclosure, a longitudinal section along a central axis of the through hole is triangular, trapezoidal, semi-circular, or arcuate.

In an embodiment of the present disclosure, a longitudinal section of an inner sidewall of the through hole is stepped, arced, or curved.

The present disclosure further provides a display panel including the polarizer described above.

In an embodiment of the present disclosure, the display panel includes in order a substrate, the polarizer attached to a surface of the substrate, and an optical adhesive layer coated on a surface of the polarizer away from the substrate and filled into the through hole of the polarizer.

In an embodiment of the present disclosure, the display panel further includes a cover plate attached to a surface of the optical adhesive layer away from the substrate.

In an embodiment of the present disclosure, the optical adhesive layer is completely coated on the surface of the polarizer.

In an embodiment of the present disclosure, the optical adhesive layer completely fills the through hole.

In an embodiment of the present disclosure, the substrate is a color film substrate.

The technical effect of an embodiment of the present disclosure is to provide a polarizer and a display panel. An inner diameter of a through hole of the polarizer gradually decreases from an upper end to a lower end, such that an inner sidewall of the through hole forms a gentle slope or a stepped slope, when a liquid optical adhesive is filled in the through hole, the through hole can be completely filled to prevent air bubbles from being generated between the optical adhesive and the inner sidewall of the through hole, thereby improving a yield of the display panel and improving a light transmittance of the through hole.

### DESCRIPTION OF DRAWINGS

The accompanying figures to be used in the description of embodiments of the present disclosure will be described in brief to more clearly illustrate the technical solutions of the embodiments. The accompanying figures described below are only part of the embodiments of the present disclosure, from which figures those skilled in the art can derive further figures without making any inventive efforts.

FIG. 1 is a longitudinal sectional view of a display panel according to an embodiment of the present disclosure.

FIG. 2 is a longitudinal sectional view of another display panel according to an embodiment of the present disclosure.

FIG. 3 is a longitudinal sectional view illustrating a polarizer cutting tool according to an embodiment of the present disclosure.

FIG. 4 is a longitudinal sectional view illustrating another polarizer cutting tool according to an embodiment of the present disclosure.

### DETAILED DESCRIPTION OF PREFERRED EMBODIMENTS

The technical solutions in the embodiments of the present disclosure will be clearly and completely described in the following with reference to the accompanying drawings. It is apparent that the described embodiments are only a part of the embodiments of the present disclosure, and not all of the embodiments. All other embodiments obtained by a person skilled in the art based on the embodiments of the present disclosure without creative efforts are within the scope of the present disclosure.

The terms used in the description of the present disclosure are intended to describe the specific embodiments and are not intended to illustrate the concept of the present disclosure. Expressions used in the singular encompasses the plural forms of expression unless the context clearly dictates otherwise. In the description of the present disclosure, it is to be understood that the terms such as “comprise”, “have”, “contain”, are intended to indicate the possibility of having features, numbers, steps, acts, or combinations thereof disclosed in the description herein. The possibility of one or more other features, numbers, steps, actions, or combinations thereof may be excluded. The same reference numerals in the drawings denote the same parts.

Embodiments of the present disclosure provide a polarizer and a display panel. The details will be described below.

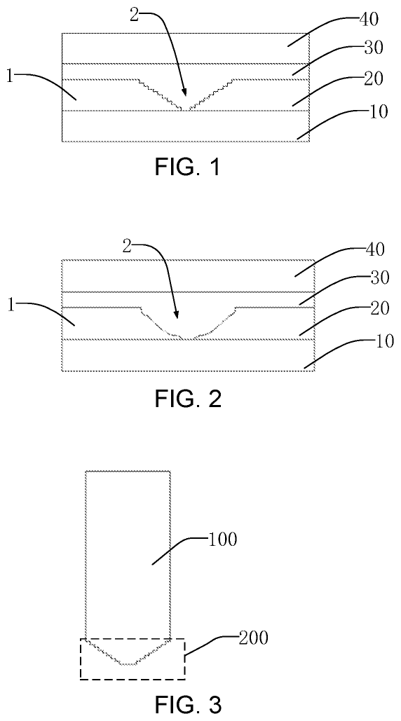

FIG. 1 and FIG. 2 illustrate that an embodiment provides a polarizer including a polarizer body 1 and a through hole 2. The through hole 2 penetrates through the polarizer body 1. Two ends of the through hole 2 are respectively disposed on an upper substrate and a lower surface of the polarizer body 1. An inner diameter of the upper end of the through hole 2 is greater than an inner diameter of the lower end of the through hole 2, and the inner diameter of the through hole 2 gradually decreases from the upper end to the lower end.

As illustrated in FIG. 1, a display panel is provided in the embodiment. The display panel includes in order a substrate 10, a polarizer 20, an optical adhesive layer 30, and a cover plate 40.

In the embodiment, the substrate 10 is preferably a color film substrate. The color film substrate mainly filters a backlight into three primary colors of red, green, and blue to realize different color display.

The polarizer 20 is attached to an upper surface of the substrate 10. The polarizer 20 includes the polarizer body 1 and the through hole 2, which have been described in detail above and will not be described herein.

A main component of the optical adhesive layer 30 is acrylic resin, which is colorless and transparent, has a light transmittance of 90% or more, has good bonding strength, can be cured at room temperature, and has a small curing shrinkage.

Liquid optical adhesive is coated on an upper surface of the polarizer 20, and is filled as much as possible, such that the liquid optical adhesive is filled into the through holes 2 of the polarizer 20. The liquid optical adhesive flows into the through holes 2 during a coating process. Because the inner diameter of the through hole 2 gradually decreases from the upper end to the lower end, which is similar to a funnel shape, the liquid optical adhesive flows from an upper portion to a lower portion along an inner sidewall of the through hole 2, and the through hole 2 is gradually filled and completely filled to prevent air bubbles from being generated in a filling process, thereby improving a yield of the display panel and improving a light transmittance of the through hole 2. The inner sidewall of the through hole 2 is relatively smooth, and the liquid optical adhesive flows along the inner sidewall of the through hole 2, and flows from the upper surface of the polarizer 20 to a bottom of the through hole 2, thereby ensuring that no air bubbles are generated during the filling process.

The cover plate 40 is attached to the upper surface of the optical adhesive layer 30, and the cover plate 40 has strong external impact resistance.

As illustrated in FIG. 3, a longitudinal section of the inner sidewall of the through hole 2 is stepped. The through hole 2 is vertically boring on the polarizer 20 by a polarizer cutting tool, such that the longitudinal section of the inner sidewall is stepped. A blade body 100 of the polarizer cutting tool is a cylinder, and a cutter head 200 is a vertebral body. A longitudinal section of the vertebral cutter head 200 is stepped, such that the liquid optical adhesive flows down a step of the inner sidewall of the through hole 2, and gradually fills the through hole 2 to avoid bubbles generated during the filling process, thereby improving a yield of the display panel and a light transmittance of the through hole 2.

As illustrated in FIG. 2, in another embodiment of the present disclosure, a longitudinal section of the inner sidewall of the through hole 2 of the polarizer 20 may be curved. The inner sidewall of the through hole 2 is relatively smooth, and the liquid optical adhesive flows along the inner sidewall of the through hole 2. Therefore, during a coating process, the liquid optical adhesive flows along the upper surface of the polarizer 20 to the through hole 2, passes along a curve of the inner sidewall of the hole 2, and gradually flows downward, and the through hole 2 is gradually filled, thereby ensuring that no air bubbles are generated during the filling process, thereby improving a yield of the display panel and improving a light transmittance of the through hole 2.

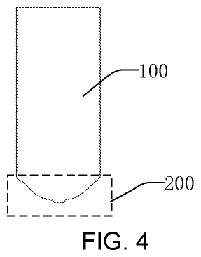

As illustrated in FIG. 4, the through hole 2 is vertically boring on the polarizer 20 by a polarizer cutting tool, such that the longitudinal section of the inner sidewall is curved. The blade body 100 of the polarizer cutting tool is a cylinder, the cutter head 200 is a vertebral body, and the longitudinal section of the vertebral cutter head 200 has a curved shape, such that a three-dimensional figure of the through hole 2 approximates a funnel, that is, the inner diameter of the through hole 2 gradually decreases from the upper end to the lower end.

In the above embodiment, the longitudinal section of the inner sidewall of the through hole of the polarizer may be a stepped shape, a curved shape, or an arc shape, but is not limited thereto. As long as the three-dimensional figure of the through hole can be approximated to a funnel, that is, the inner diameter of the through hole gradually decreases from one end to another end, thereby ensuring that the optical adhesive does not generate bubbles when filling the through hole, thereby a display performance of the display panel is improved and a light transmittance of the through hole of the polarizer is improved.

The polarizer and the display panel provided by the embodiments of the present disclosure are described in detail above. It is understood that the exemplary embodiments described herein are to be considered as illustrative only, and are not intended to limit the present disclosure. Descriptions of features or aspects in each exemplary embodiment should generally be considered as suitable features or aspects in other exemplary embodiments. While the present disclosure has been described with reference to the preferred embodiments thereof, various modifications and changes can be made by those skilled in the art. The present disclosure is intended to cover such modifications and modifications within the scope of the appended claims.

What is claimed is:

1. A polarizer, comprising:
a polarizer body; and
a through hole penetrating through the polarizer body;
wherein, an inner diameter of one end of the through hole is greater than an inner diameter of another end of the through hole.

2. The polarizer according to claim 1, wherein the inner diameter of the through hole gradually decreases from the one end of the through hole to the another end of the through hole.

3. The polarizer according to claim 1, wherein a longitudinal section along a central axis of the through hole is triangular, trapezoidal, semi-circular, or arcuate.

4. The polarizer according to claim 1, wherein a longitudinal section of an inner sidewall of the through hole is stepped, arced, or curved.

5. A display panel comprising the polarizer of claim 1.

6. The display panel according to claim 5, comprising in order:
a substrate;
the polarizer attached to a surface of the substrate; and
an optical adhesive layer coated on a surface of the polarizer away from the substrate and filled into the through hole of the polarizer.

7. The display panel according to claim 6, further comprising a cover plate attached to a surface of the optical adhesive layer away from the substrate.

8. The display panel according to claim 6, wherein the optical adhesive layer is completely coated on the surface of the polarizer.

9. The display panel according to claim 6, wherein the optical adhesive layer completely fills the through hole.

10. The display panel according to claim 6, wherein the substrate is a color film substrate.
